(19) United States
(12) Patent Application Publication
(10) Pub. No.: US 2017/0111743 A1
(43) Pub. Date: Apr. 20, 2017

(54) Apparatus and Method for Detecting and Driving Headphones Differentially in Mobile Applications

(71) Applicant: ESS Technology, Inc., Milpitas, CA (US)

(72) Inventors: Peter John Frith, Kelowna (CA); Frederic Schrive, Kelowna (CA); Hwang Soo Son, Cupertino, CA (US); Dustin Dale Forman, Kelowna (CA)

(21) Appl. No.: 15/261,937

(22) Filed: Sep. 10, 2016

Related U.S. Application Data
(60) Provisional application No. 62/217,585, filed on Sep. 11, 2015.
(60) Provisional application No. 62/309,924, filed on Mar. 17, 2016.

(51) Int. Cl. H04R 5/04; H04R 29/00

(52) U.S. Cl. CPC H04R 5/04; H04R 29/001; H04R 2420/01; H04R 2420/05; H04R 2499/11

(57) ABSTRACT

An apparatus and method is disclosed for achieving improved sound quality from mobile ‘hifi’ playback devices by driving compatible headphones in ‘balanced’ or ‘differential’ mode via standard size headphone connectors on the device, while retaining full compliance with legacy jack connections and conventional headphones. When a headphone is connected, a smartphone may determine whether the headphone is one capable of accepting balanced audio signals, or one that uses a conventional 3-pole jack or a 4-pole CTIA or OMTP jack. For a headphone that accepts balanced audio signals, the four poles of a 4-pole jack are used to drive left and right audio channels, and inverted left and right audio channels. For conventional 3-pole or 4-pole jacks, switches in the smartphone adapt the audio output signals to the configuration expected by the headphone.

This application claims priority from Provisional Applications Nos. 62/217,585, filed Sep. 11, 2015, and 62/309,924, filed Mar. 17, 2016, which are incorporated by reference herein in their entirety.

### FIELD OF THE INVENTION

The present invention relates generally to mobile devices, and more particularly to driving headphones through an analog output port in such a mobile device.

### BACKGROUND OF THE INVENTION

It is now common for people to listen to music using mobile devices such as smartphones or other mobile media players (collectively “smartphones”). Users have rapidly become accustomed to having music played back through such devices, and often tend to have their smartphones with them at all times. At least many, if not most, of these users want to be able to listen to music having high sound quality. Smartphone makers have recognized this, and many have introduced ‘hifi’ smartphones, and even based much of their marketing strategy on their ability to deliver better quality sound reproduction than was available previously.

While smartphones have small loudspeakers, often used for making telephone calls and “speakerphone” calls, and may alternatively be connected to some external loudspeaker, many, if not most, users listen to music from their smartphones on headphones. A typical headphone to be used with a smartphone is an analog output device that includes a plug that fits into an analog port on the smartphone, and one or more earpieces that contain transducers that are activated by signals from the smartphone and produce sound to the user. The term “headphone” includes both over-ear devices that are often referred to as “headphones,” as well as in-ear devices that are often called “ear buds.”

An output audio signal is sent from the smartphone by an audio subsystem in the smartphone to the earpiece(s) in the headphone and activates the transducers to produce sound so that a user may listen to the audio output. The analog port typically contains two output channels, referred to in the art as “Left” and “Right” (and generally intended to go to the left and right ear of the user, respectively), so as to be capable of providing stereo audio output. If the headphone includes two earpieces and the source material has been recorded in a stereo format, one channel will go to each earpiece and the user will hear stereo audio output. Other devices, such as some eternal loudspeakers and amplifiers, may also have a plug that fits into the analog port to receive the output audio in stereo.

While current smartphones are able to reproduce stereo music with high sound quality, they are typically sold with included headphones that tend to be of mediocre or even poor quality, thus limiting the user's musical experience. It is thus not uncommon for the purchaser of a new smartphone to almost immediately discard the included headphones and purchase a set of after-market headphones of higher quality than those included in order to take full advantage of the ability of the smartphone to play music with high sound quality.

However, the performance of even high quality headphones is typically limited by the performance of the connection from the audio output port on the smartphone to the headphone transducers, and how the audio signals are provided to the headphones.

The industry-standard analog port for outputting audio from the smartphone typically has a receptacle known as a “socket” that accepts an inserted element, most often a 3.5 millimeter (mm) “jack” or plug. (A less common alternative is a port that accepts a 2.5 mm jack.) One version of the industry standard jack is shown in FIG. 1a. Jack 102 has three segments or poles, which are electrically isolated from each other and connect to separate wires or components of the headphone or other device being plugged into the analog port. The three poles are commonly known in the art as the Tip, the Ring, and the Sleeve. The analog port socket similarly has three segments (not shown) which match up and connect to the three poles of jack 102 when fully inserted into the socket, and which are also electrically isolated from each other and connect to separate components of the smartphone.

FIG. 2 shows the typical way that a stereo signal is output from the analog port of a smartphone to a 3-pole jack such as 3-pole jack 102 of FIG. 1. In particular, the jack and socket configuration used in standard headphone connections separates the Left and Right signal paths onto separate wires. The Left channel audio signal, labeled LP, is fed through the Tip portion of jack 102, while the Right channel audio signal, labeled RP is fed through the Ring of jack 102.

However, since jack 102 only has a 3-pole connection, and two of the poles are used for the Left and Right outputs, this configuration thus requires that the ground return signal paths for both channels, labeled LGnd and RGnd, are shared through the Sleeve of the jack, and then through the socket connection to the smartphone and across the internal device circuit board.

This common grounding of the channels results in crosstalk and signal loss through the parasitic resistance of this shared signal ground return path. While there are some specific circuit implementations that have been tried to mitigate these issues, for example where feedback to the amplifiers is taken from as close to the jack common ground point as possible, ultimately it is not possible to avoid the common grounding of the left and right signal return paths in a 3-pole connector.

Returning to FIG. 1b, another version of the industry standard jack is shown, in which a jack 104 now contains 4 poles. Two of the poles are designated in the same way as those of 3-pole jack 102 of FIG. 1a, i.e., the Tip and the Sleeve. The third pole, called the Ring in a 3-pole jack, is now called Ring1 to distinguish it from the fourth pole, which is located between Ring1 and the Sleeve and known in the art as Ring2. The analog port socket (not shown) similarly contains a fourth segment that corresponds to Ring2 and connects with Ring2 when jack 102 is fully inserted into the socket.

In most mobile communication devices such as smartphones the extra pole on the standard 3.5 mm jack, and the corresponding portion of the socket, is used to support connection of a microphone in the headset for voice communication. A headphone including a microphone is sometimes called a “headset”; as used herein, “headphone” includes headsets. As is well known in the art, many headsets include a device, sometimes called a “dongle,” that includes one or more buttons that the user may press to select certain functions from the audio subsystem in the smartphone, such as to answer a telephone call, pause or play audio, or increase or decrease the volume of the transducers in the headset. This device is typically located on the cord from the earpieces of the headphone to the jack.

It will be apparent that, although the jack and socket arrangement is now a 4-pole jack, there is still only one pole available for the ground return signals of the Left and Right audio channels, and now for the microphone as well.

There are two industry-standard configurations of a 4-pole jack presently in use with smartphones. FIG. 3 is a diagram of a 4-pole jack 302 of one configuration. This configuration is known as the CTIA standard, for the organization that adopted it (originally known as the Cellular Telephone Industries Association), or alternatively as the American Headset Jack (AHJ) standard.

In a CTIA configuration, as with the 3-pole configuration of FIG. 2, the left and right audio channel signals LP and RP are passed to the headphone through the Tip and Ring1 of jack 302, respectively. In addition, the microphone output, which is not present in the 3-pole configuration, is passed through the Sleeve portion of jack 302. The ground connector for both the Left and Right channel signals now also includes the microphone signal, and is connected to Ring2.

The second common configuration is the OMTP standard (from the Open Mobile Terminal Platform). FIG. 4 is a diagram of this configuration of a 4-pole jack 402. As with the CTIA configuration and the 3-pole configuration, the left and right audio channel signals LP and RP are passed to the headphone through the Tip and Ring1 of jack 402, respectively.

As compared to the CTIA configuration, however, the OMTP configuration reverses the connections of the microphone and ground, so that the ground signal return paths, again for both audio channels and the microphone signal, are through the Sleeve, while the microphone signal is passed to the headphone through Ring2.

However, as with the 3-pole jack 202 of FIG. 2, where a 4-pole jack is used, and regardless of whether the 4-pole jack uses the CTIA or OMTP standard, in each case the level of audio quality is constrained by the use of a common ground for the left and right channel signal return paths, as well as the microphone signal where a microphone is present. Thus, the crosstalk and signal loss problems of the 3-pole jack 102 above are still present, and in fact are exacerbated by the fact that the common ground signal return path now includes the microphone signal as well as the Left and Right channel signals.

All known smartphone or other mobile audio devices use audio output sockets configured to accept industry standard 3-pole jacks or CTIA or OMTP 4-pole jacks. Thus, all such known devices provide common ground signal return paths, and thus suffer from these described audio signal quality issues. It would be advantageous to be able connect high quality headphones to mobile devices in such a way as to avoid the need for a common ground return path for left and right channel audio signals.

### SUMMARY OF THE INVENTION

An apparatus and method is described whereby improved sound quality is achieved from mobile ‘hifi’ playback devices by driving compatible headphones in ‘balanced’ or ‘differential’ mode via standard size headphone connectors on the device, while retaining full compliance with legacy jack connections and conventional headphones. An apparatus and method for determining the type of headphone or other reproduction device connected to the playback device and configuring the playback device to produce an audio output appropriate for the connected device is also described.

One embodiment discloses a mobile audio device for producing a balanced stereo signal, comprising: an analog audio output socket having 4 poles and configured to receive a 4-pole jack corresponding to either the CTIA or OMTP standard; a first amplifier for providing a left channel audio signal to a first pole of the output socket corresponding to a Tip of the jack; a second amplifier for providing a right channel audio signal to a second pole of the output socket corresponding to a Ring1 of the jack; a third amplifier for providing an inverted left channel audio signal of opposite phase to the left channel audio signal to a third pole of the output socket; and a fourth amplifier for providing an inverted right channel audio signal of opposite phase to the right channel audio signal to a fourth pole of the output socket.

Another embodiment discloses a method of producing a balanced stereo signal from a mobile audio device having an analog audio output socket with 4 poles and configured to receive a 4-pole jack corresponding to either the CTIA or OMTP standard, comprising: providing a left channel audio signal to a first pole of the output socket corresponding to a Tip of the jack; providing a right channel audio signal to a second pole of the output socket corresponding to a Ring1 of the jack; providing an inverted left channel audio signal of opposite phase to the left channel audio signal to a third pole of the output socket; and providing an inverted right channel audio signal of opposite phase to the right channel audio signal to a fourth pole of the output socket.

A further embodiment discloses a mobile audio device for producing a balanced stereo signal, comprising: an analog audio output socket having 4 poles and configured to receive a 4-pole jack corresponding to either the CTIA or OMTP standard; a first amplifier for providing a left channel audio signal; a second amplifier for providing a right channel audio signal; a third amplifier for providing an inverted left channel audio signal of opposite phase to the left channel audio signal; a fourth amplifier for providing an inverted right channel audio signal of opposite phase to the right channel audio signal; and a controller configured to: measure the impedances between a first pole of the socket and a second pole of the socket, the first pole and a third pole of the socket, a fourth pole of the socket and the second pole, and the fourth pole and the third pole; compare the measured impedances to expected values for devices using 3-pole jacks, devices using 4-pole jacks corresponding to the CTIA or OMTP standards, and devices using 4-pole jacks that can accept a balanced stereo signal; determine which of the devices is indicated by the measured impedances, and, if the device is one that can accept a balanced stereo signal, and cause the left channel audio signal to be provided to a first pole of the output socket corresponding to a Tip of the jack, the right channel audio signal to be provided to a second pole of the output socket corresponding to a Ring1 of the jack, the inverted left channel audio signal to be provided to a third pole of the output socket, and the inverted right channel audio signal to be provided to a fourth pole of the output socket.

Still another embodiment discloses a method of producing a balanced stereo signal from a mobile audio device having an analog audio output socket with 4 poles and configured to receive a 3-pole jack or a 4-pole jack corresponding to either the CTIA or OMTP standard, comprising: measuring the impedances between a first pole of the socket and a second pole of the socket, the first pole and a third pole of the socket, a fourth pole of the socket and the second pole, and the fourth pole and the third pole; comparing the measured impedances to expected values for attached sound reproduction devices using 3-pole jacks, devices using 4-pole jacks corresponding to the CTIA or OMTP standards, and devices using 4-pole jacks that can accept a balanced stereo signal; determining which attached sound reproduction device is indicated by the measured impedances, and, if the attached sound reproduction device is one that can accept a balanced stereo signal: providing a left channel audio signal to a first pole of the socket corresponding to a Tip of the jack; providing a right channel audio signal to a second pole of the socket corresponding to a Ring1 of the jack; providing an inverted left channel audio signal of opposite phase to the left channel audio signal to a third pole of the socket; and providing an inverted right channel audio signal of opposite phase to the right channel audio signal to a fourth pole of the socket.

### BRIEF DESCRIPTION OF THE DRAWINGS

FIGS. 1a and 1b are illustrations of the configuration of prior art industry-standard 3-pole and 4-pole jacks for use with a standard analog port on a mobile device such as a smartphone.

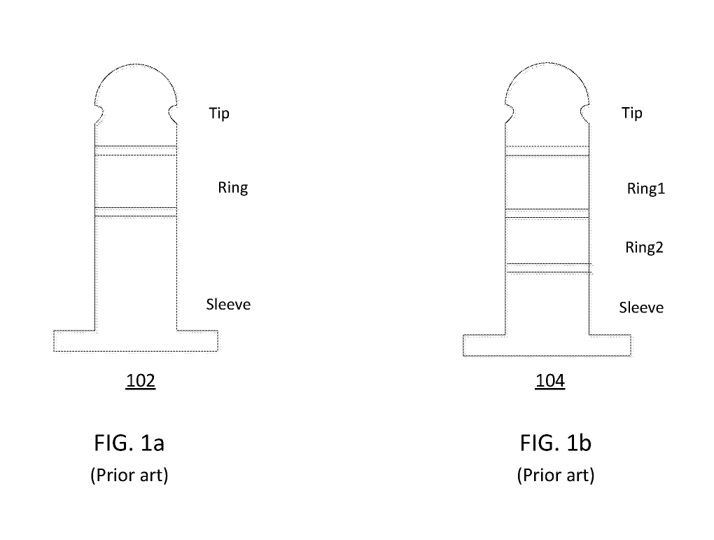

FIG. 2 is an illustration of how signals pass through a prior art industry-standard 3-pole jack for use with an analog port on a mobile device.

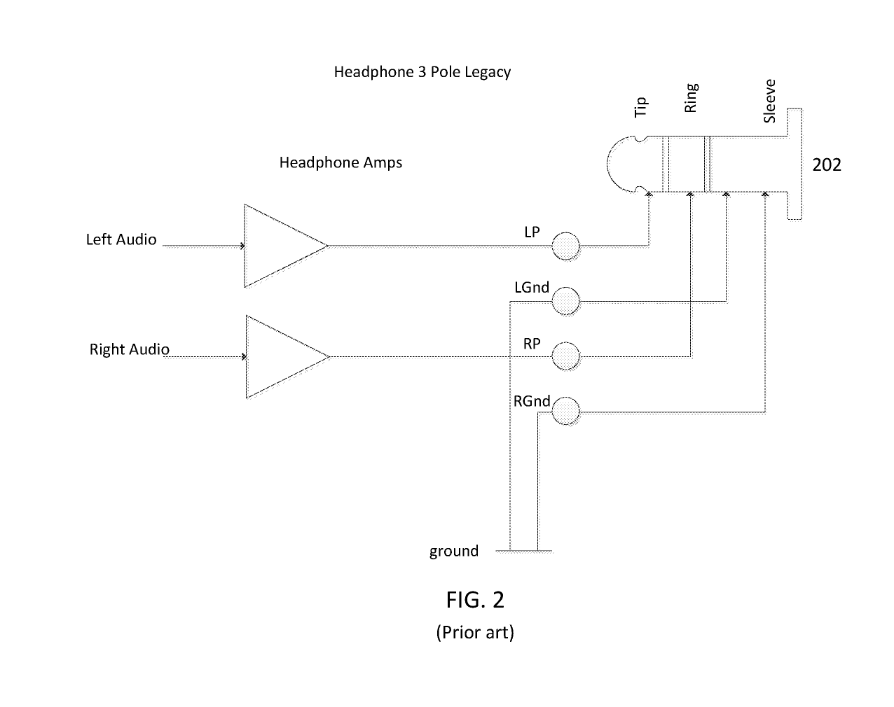

FIG. 3 is a diagram of how signals pass through a prior art industry-standard 4-pole jack for use with an analog port on a mobile device using the CTIA standard configuration.

FIG. 4 is a diagram of how signals pass through a prior art industry-standard 4-pole jack for use with an analog port on a mobile device using the OMTP standard configuration.

FIG. 5 shows some components of one embodiment of an audio subsystem of a smartphone that is capable of producing a balanced output to a high-quality headphone while using a standard size 4-pole jack.

FIG. 6 shows an embodiment in which the audio subsystem of a smartphone as shown in FIG. 5 may be used to provide audio to a standard 4-pole jack and headphone having a CTIA configuration.

FIG. 7 shows an embodiment in which the audio subsystem of a smartphone as shown in FIG. 5 may be used to provide audio to a standard 4-pole jack and headphone having an OMTP configuration.

FIG. 8 shows an embodiment in which the audio subsystem of a smartphone as shown in FIG. 5 may be used to provide audio to a standard 3-pole jack and headphone without a microphone.

FIG. 9 is a flowchart of a method for operating the audio subsystem of a smartphone that can support balanced headphones according to one embodiment.

### DETAILED DESCRIPTION OF THE INVENTION

Described herein is an apparatus and method whereby improved sound quality may be achieved from mobile ‘hifi’ playback devices by driving compatible headphones in a way that the left and right channel signals have separate ground return paths via standard size headphone connectors on the device rather than having a common ground return path, while retaining full compliance with legacy jack connections and conventional headphones. The type of headphone or other reproduction device connected to the playback device may be determined by a controller and the playback device configured to produce an audio output appropriate for the connected device.

Some high-quality headphones used for applications other than mobile devices have separate left and right channel signal return paths, rather than being connected in common as in mobile devices. Audio equipment professionals commonly refer to the use of separate signal return paths as a “balanced” or “differential” connection; such high-quality headphones that have separate signal return paths are referred to as “balanced headphones” herein.

Balanced headphones improve the sound quality for the user by eliminating the crosstalk and signal loss caused by common signal return paths as described above. In addition, the return signals may be actively driven in opposite phase to the left and right channel signals; this is sometimes also known as a “fully balanced” connection, as distinguished from separate signal return paths only. As used herein, a balanced connection includes a fully balanced connection as well.

Such prior art balanced headphones are intended for use with non-portable stereo systems, and use what is known as an XLR style connector. However, in the first instance the XLR connector is physically incompatible with smartphones (or other mobile devices). Further, the sockets used with balanced headphones are dedicated to that purpose, and do not provide the signals used by, or accept microphone signals from, CTIA or OMTP headphones.

It may thus be seen that connecting balanced headphones to a mobile device capable of providing separate signal return paths would improve the sound quality for the user. Again, however, the required signals are different from, and at least partly incompatible with, those used by conventional headphones designed for use with mobile devices.

Since a 4-pole jack by definition has 4 separate signal paths available, such a jack can be configured in a way that drives the desirable “balanced” left and right signal pairs into the headphone totally separately, providing higher quality sound than the conventional CTIA or OMTP configurations. In order to support this connection, the headphone must include a matching 4-pole jack. Because there are 4 poles, both 3.5 mm and 2.5 mm 4-pole jack and socket configurations can support this connection, although not in the conventional CTIA or OMTP configurations.

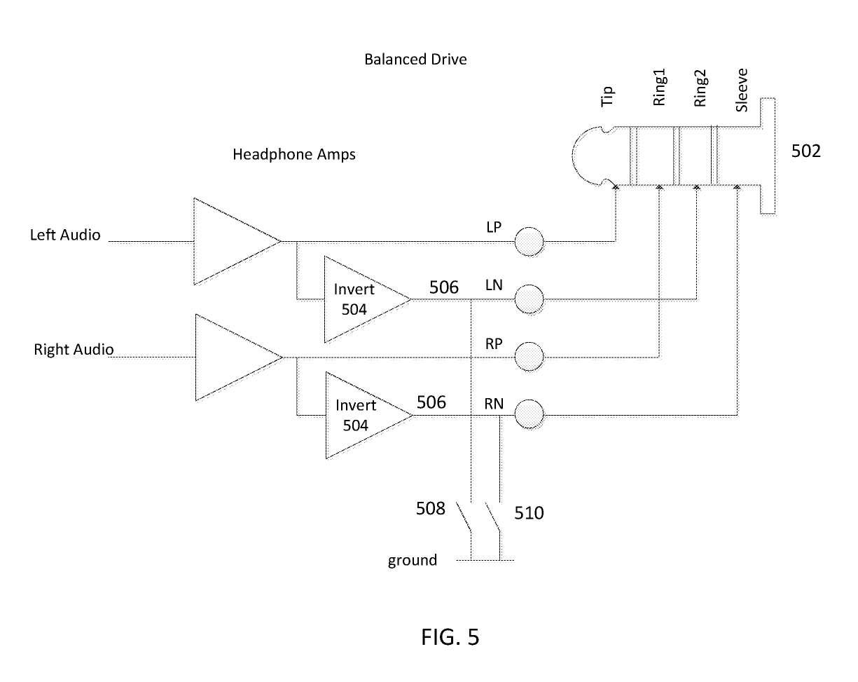

FIG. 5 shows some components of one embodiment of an audio subsystem of a smartphone that is capable of producing a balanced output to a high-quality headphone while using a standard size 4-pole jack 502. The left audio channel signal LP is connected to the Tip of jack 502, and the right audio channel signal RP is connected to Ring1 as in the prior art discussed above. These audio channel signals LP and RP are produced in the same fashion as in the prior art.

In addition, the audio production subsystem in the smartphone also has inverters 504, which invert the left and right audio channel signals LP and RP, and produce “inverted” left and right channel audio signals LN and RN, i.e., signals which are of opposite phase to left and right audio channel signals LP and RP, respectively. The inverted left audio channel signal LN is connected to Ring2 of jack 502, and the inverted right audio channel signal RN is connected to the Sleeve.

The inverters 504 are connected to Ring2 and the Sleeve by switches 506, which are not visible in FIG. 5 as they are in a closed position. Their function will be explained further below.

In the “fully balanced” configuration of FIG. 5, as described above, the inverted audio channel signals LN and RN also function as separate ground return paths of the left channel signal LP through Ring2, and of the right channel RP through the Sleeve. It may thus be seen that while the configuration of plug 502 of FIG. 5 allows the use of a standard 4-pole jack and socket, neither the audio source nor the headphone are designed or operating in a CTIA or OMTP configuration, but rather in the balanced configuration described.

In the illustrated embodiment, switches 508 and 510 are also provided for use as described below. When a balanced headphone is used and audio output is produced, switches 508 and 510 are open as shown so that the inverted audio channel signals LN and RN are not connected to ground but are passed to jack 502 as described above.

Note that while the configuration of FIG. 5 preserves the standard connection of the left channel audio signal LP to the Tip and the right channel audio signal RP to Ring1, it is arbitrary whether the inverted left channel signal LN is connected to Ring2 and the inverted right channel signal RN to the Sleeve or vice versa. As illustrated, FIG. 5 shows a “LRLR” configuration since the left and right channel signals alternate along the jack 502. It will be clear that switching the connection of the inverted left channel signal LN to the sleeve, and the inverted right channel signal RN to Ring2, will function in the same fashion; such a configuration may be thought of as a “LRRL” configuration since the two right channel signals will be located on adjacent Ring1 and Ring2 portions of the jack.

As with balanced headphones used in non-smartphone applications, providing these audio signals from a smartphone to a balanced headphone will result in better audio quality for the user than that provided by conventional headphones. As above, this is due to the elimination of crosstalk and the signal loss due to parasitic resistance discussed above.

However, even if smartphones are manufactured with the ability to provide balanced audio signals, it is expected that some users will choose to use conventional headphones rather than high quality balanced headphones. This may be due to the increased cost of balanced headphones as compared to conventional headphones, or alternatively to the fact that a balanced headphone does not support a microphone.

It is thus apparent that it will also be desirable to make a smartphone which is capable of providing balanced audio signals also capable of operating with other standard, non-balanced headphones in the conventional ways described above. To accomplish this, the audio production subsystem of the smartphone may be designed to allow for proper operation with any standard headphone by configuring the connections to the socket so as to feed appropriate signals to each different type of headphone.

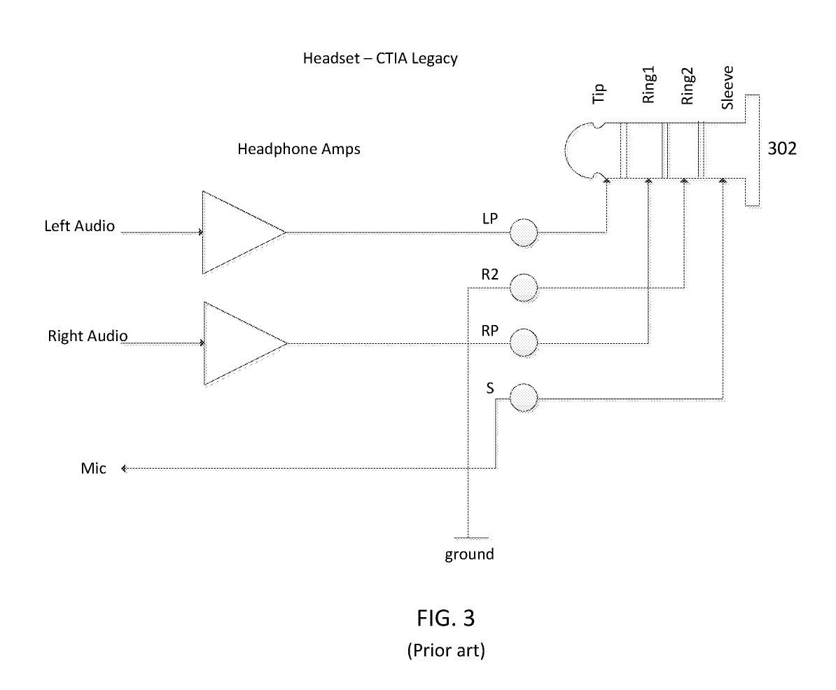

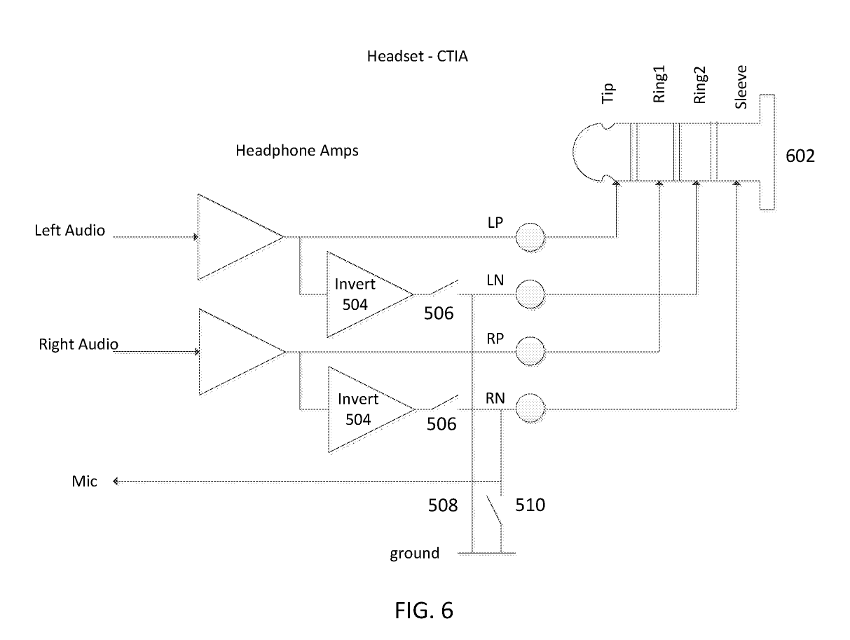

FIG. 6 shows an embodiment in which the components of the audio subsystem of a smartphone as shown in FIG. 5 may be used to provide audio to a standard 4-pole jack 602 and headphone having the CTIA configuration as shown in FIG. 3 above. As in the configuration of FIG. 3, in FIG. 6 the left audio channel signal LP is connected to the Tip of jack 602, and the right audio channel signal RP is connected to Ring1, as in the prior art described above.

In this instance, however, switches 506 are opened so that inverted signals from inverters 504 are not provided to Ring2 and the Sleeve, respectively, since the inverted signals are not used by a CTIA headphone. Rather, as in the standard CTIA configuration shown in FIG. 3, the microphone signal MIC is provided through the Sleeve, and the return ground signals for both the left and right audio channels and the microphone are passed through Ring2 and to ground through closed switch 508. Switch 510 is opened so that the microphone signal is connected to the sleeve and not to ground.

In this way, the connection of FIG. 6 allows a smartphone having the ability to produce a balanced signal to a high quality headphone to also provide signals appropriate for a headphone including the use of a microphone as set forth in the CTIA standard above.

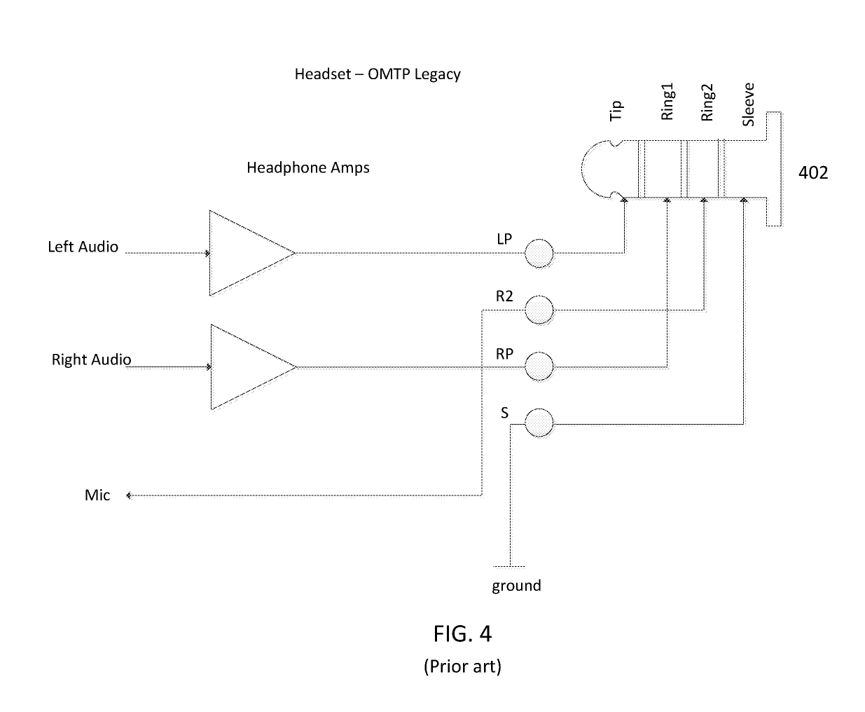

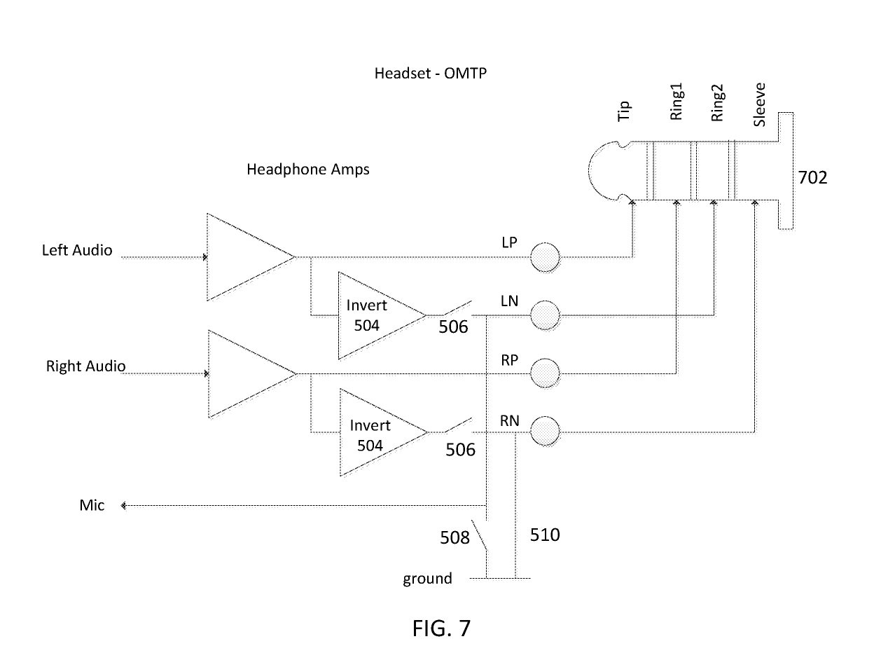

FIG. 7 shows an embodiment in which the audio subsystem of a smartphone as shown in FIG. 5 may similarly be used to provide audio to a standard 4-pole jack 702 and headphone having the OMTP configuration as shown in FIG. 4 above. As in the OMTP configuration of FIG. 4, in FIG. 7 the left audio channel signal LP is connected to the Tip of jack 702, and the right audio channel signal RP is connected to Ring1, again as in the prior art discussed above.

As with the use of a CTIA headphone and jack as in FIG. 6, switches 506 are opened so that no inverted signals from inverters 504 are provided to Ring2 and the Sleeve, respectively. Now, as in the standard OMTP configuration shown in FIG. 4, the microphone signal MIC is provided through Ring2, and the return ground signals for both the left and right audio channels and the microphone are passed through the Sleeve and to ground through closed switch 510. Switch 508 is opened so that the microphone signal is connected to Ring2 and not to ground.

In this way, the connection of FIG. 7 allows a smartphone having the ability to produce a balanced signal to a high quality headphone to also provide signals appropriate for a headphone including the use of a microphone as set forth in the OMTP standard above.

As with the CTIA and OMTP configurations of FIGS. 3 and 4 above, it will be seen that the configurations of FIGS. 6 and 7 are similar, with the connections to Ring2 and the Sleeve being reversed, and corresponding switches open rather than closed and vice versa as appropriate.

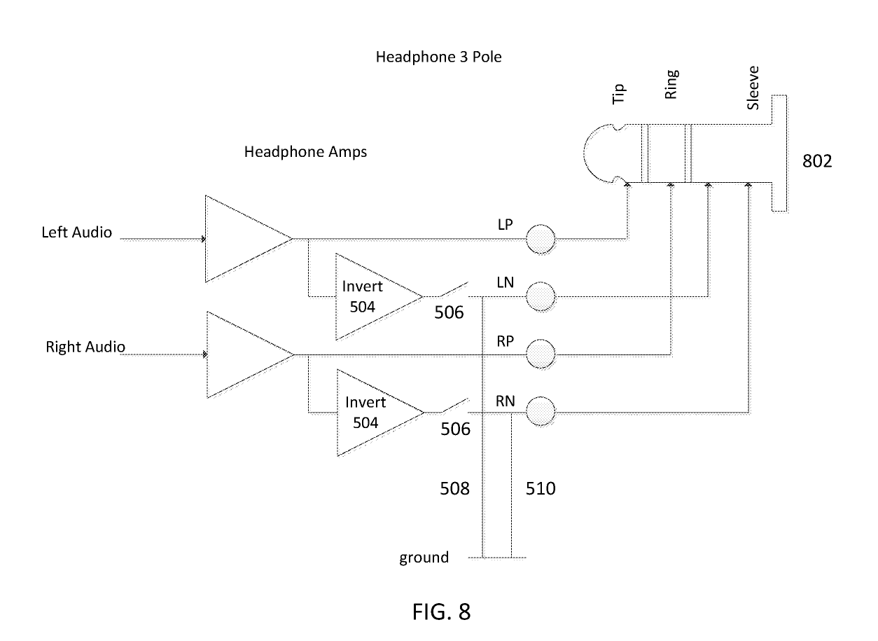

FIG. 8 shows an embodiment in which the audio subsystem of a smartphone as shown in FIG. 5 may similarly be used to provide audio to a standard 3-pole jack 802 and corresponding headphone with no microphone. As in the prior art configuration of FIG. 3, in FIG. 8 the left audio channel signal LP is connected to the Tip of jack 802, and the right audio channel signal RP is connected to Ring1.

As with the use of the prior art CTI and OMTP headphones above, switches 506 are opened so that no inverted signals from inverters 504 are provided to Ring2 and the Sleeve, respectively. Since there is only a 3-pole jack 802, both the left and right channel ground return signals pass through the Sleeve of jack 802, and thus switches 508 and 510 are both closed to provide the connections for both signals to ground.

In this way, the connection of FIG. 8 allows a smartphone having the ability to produce a balanced signal to a high quality headphone to also provide signals appropriate for a 3-pole headphone that does not include a microphone.

It can thus be seen that an appropriately designed audio subsystem in a smartphone may be capable of driving compatible headphones in ‘balanced’ or ‘differential’ mode via standard size headphone connectors on the device, as well as retaining full compliance with legacy jack connections and conventional headphones and providing appropriate signals to such headphones.

It is desirable that the user be able to plug any headphone into the audio port socket of a smartphone and hear the audio output without any selection by the user of the type of headphone connected. Thus, the audio subsystem should preferably be able to automatically detect that a jack has been inserted into the socket, and to determine what type of headphone has been connected.

The audio subsystem must first be able to detect that a headphone has been connected, i.e., that a jack has been inserted into the audio output socket. This detection is known in the art, and is typically done by the use of one or more “jack detect pins.” The jack detect pins are extra contacts inside the socket, which act as switches. The pins only sense that the plug is inserted, and are not intended for the audio signal.

When a jack is not present, the jack detect pins, or switches, are closed; when the jack is inserted, the jack flexes some of the jack detect pins, and they break contact with other of the jack detect pins so that the switches are open. The system depends on the mechanical deformation of the jack detect pins to break the connections between the jack detect pins and open the switches. Thus, for example, a 3.5-mm plastic rod could be inserted into the socket and still open the contacts, and the smartphone will think that headphones are plugged in.

Once the insertion of a jack has been detected, as discussed above there are several types of devices that a smartphone will preferably be able to detect. One way to detect the connected device that is well known in the art is by measuring the impedance between the various parts of the socket that connect to the jack. This may be done by applying a signal of a known voltage to the various parts of the socket using detection pins (not shown) and measuring the current that flows in response to the signal. One of skill in the art will appreciate that if the signal is at a frequency either below or above the normal range of human hearing, the signal will be inaudible to the user.

The first type of device is a standard stereo headphone using a 3-pole jack as described above. These devices typically have an impedance of between 6 ohms and 600 ohms from the Tip to the Sleeve, and the same from Ring1 to the Sleeve. Further, there is no separate Ring2 in a 3-pole jack, and an attempt to measure the impedance from the Tip or Ring1 to Ring2 will result in measuring the impedance from the Tip or Ring1 to the Sleeve and again a value of 6 to 600 ohms. A common impedance value for such headphones is 32 ohms.

The second type of device is a headphone with microphone (i.e., a headset) using a 4-pole jack in either the standard CTIA or OMTP configuration. Again the impedance from the Tip to ground, and from Ring1 to ground, will typically be between 6 and 600 ohms, while the impedance from the microphone contact to ground will typically be between 1000 and 5000 ohms. As above, which of the microphone and ground is connected to Ring2 and which to the Sleeve depends upon whether the headphone uses the CTIA of OMTP configuration.

Thus, in a CTIA configuration, where Ring2 is the ground connection, the impedance from the Tip (left channel) to Ring2 (ground), and from Ring1 (right channel) to Ring2 (ground), will be 6 to 600 ohms. Since the microphone is connected to the Sleeve but not to ground, the impedances from the Tip to the Sleeve and from Ring1 to the Sleeve will look like open switches and thus be of high (effectively infinite) impedance.

In the OMTP configuration, again the microphone and ground connections are reversed, so the impedance from the Tip to the Sleeve (now ground), and from Ring1 to the Sleeve, will be 6 to 600 ohms, while the impedance from the Tip to Ring2 (now the microphone), and from Ring1 to Ring2, will be high or open.

The third type of device to be detected is a balanced headphone. In the “LRLR” embodiment of the present application shown in FIG. 5, the impedance between each channel signal and its return signal ground, i.e., Tip to Ring2 and Ring1 to sleeve, will similarly be between 6 and 600 ohms. The other impedances, between the Tip and the Sleeve, and between Ring1 and Ring2, will be high or open. (It will be seen that if the Ring2 and Sleeve connections are reversed so that the connections to the jack are in the “LRRL” configuration described above, the impedance measurements will similarly be reversed.)

It may thus be seen that by measuring these impedances, i.e., Tip to Ring2, Tip to Sleeve, Ring1 to Ring2, and Ring1 to Sleeve, these various types of headphones may be distinguished. Table 1 summarizes which measurements indicate which headphones (Hi Z means high impedance or open circuit):

TABLE 1

| | | 4-pole headset | | Balanced headphone | |
|---|---|---|---|---|---|
| Measure | 3-pole headphone | CTIA | OMTP | LRRL | LRLR |
| Tip to Ring2 | 6-600 ohms | 6-600 ohms | Hi Z | Hi Z | 6-600 ohms |
| Tip to Sleeve | 6-600 ohms | Hi Z | 6-600 ohms | 6-600 ohms | Hi Z |
| Ring1 to Ring2 | 6-600 ohms | 6-600 ohms | Hi Z | 6-600 ohms | Hi Z |
| Ring1 to Sleeve | 6-600 ohms | Hi Z | 6-600 ohms | Hi Z | 6-600 ohms |

Currently smartphones are able to distinguish between conventional 3-pole and 4-pole jacks and their associated devices, and between CTIA and OMTP devices, by incorporating a circuit that measures the various impedances between portions of the jack. One example of a commercial product having such capability that may be incorporated in a smartphone is a TS3A227E Autonomous Audio Accessory Detection and Configuration Switch from Texas Instruments Incorporated.

It will be obvious to one of skill in the art how to modify the circuit of the Texas Instruments chip to detect the different impedances that will also determine whether balanced headphones have been connected to the analog port socket, as well as the conventional 3-pole and 4-pole CTIA and OMTP jacks of the prior art. The impedances are measured in the same way, but balanced headphones, rather than conventional headphones, are detected when the impedance measurements are as above

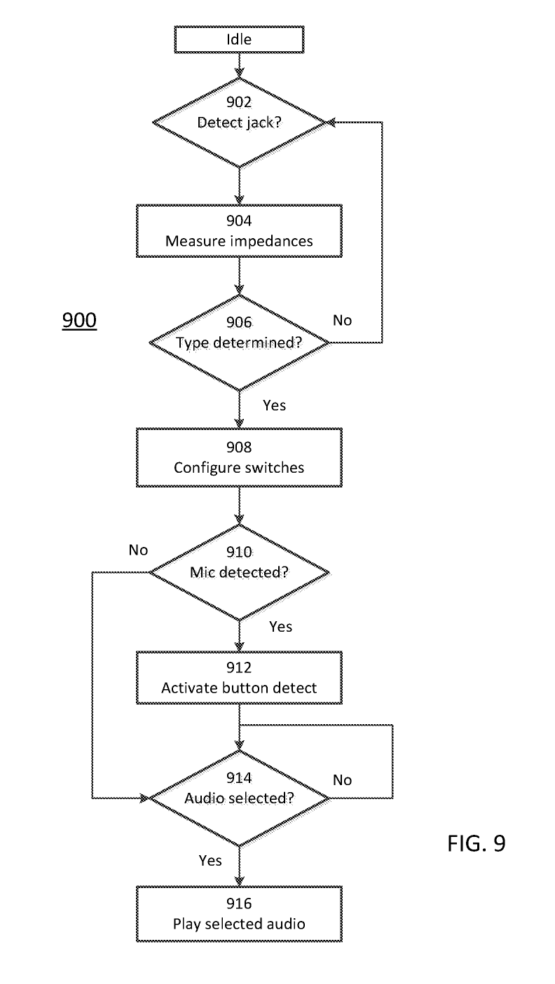

FIG. 9 is a simplified flowchart of a method of operating the audio subsystem of a smartphone that can support balanced headphones as described above. Initially the output port socket of the audio subsystem is idle. (Note that the speakers of the smartphone may be in use, for example, if the user is making a telephone call without headphones, but the socket is not activated until a jack is inserted.)

At step 902, the audio subsystem determines whether a jack has been inserted into the output port socket, typically by using jack detect pins as described above.

Once a jack is detected, at step 904 the audio subsystem will measure the impedances between portions of the jack as described above. Again, this is typically clone by driving the connections with a signal that is below or above the nominal frequency limits of human hearing, so that the user will not hear the test signal if the user has the headphones on.

Once the impedances are known, at step 906 the audio subsystem checks to see if the type of headphone has been determined. This is done by comparing the measured impedances to the expected values of each type as shown in Table 1 above. The expected values may, for example, be stored in a lookup table.

If no match to the measured impedances is found, the audio subsystem returns to the jack detect step 902 (or alternatively to the measure impedances step 904) to try again to identify the type of jack that has been inserted into the socket.

If there is a match and the type of headphone that is connected has been identified, then at step 908 the audio subsystem configures the switches by opening and/or closing switches as needed to arrive at the appropriate configuration shown in FIG. 5, 6, 7 or 8 above, depending upon whether the headphone is a balanced headphone, CM headphone, OMTP headphone, or stereo headphone with a 3-pole plug, respectively.

At step 910, the audio subsystem determines whether a microphone is detected, i.e., whether the headphone is a CTIA or OMTP headphone including a microphone. If a microphone is detected, at step 912 a portion of the audio subsystem (not shown) is enabled that detects any signals from the device or “dongle” that may be included in the headphone cord. This is well known in the art, and is typically done by sensing changes to the microphone impedance that are caused by the switching in of additional load resistors as the buttons are pressed.

At step 914, the audio subsystem determines whether the user has selected a desired audio output. This may be in the form of a telephone call, music that is stored on the smartphone (or part of a video similarly stored), or an audio stream from the internet. If an audio selection has been made, the audio subsystem delivers the selected audio to the headphone at step 916; if no audio selection has been made, the audio subsystem waits for a selection.

It will be apparent to one of skill in the art that certain of the described steps of the method of FIG. 9 in practice may actually require multiple sub-steps to implement in a smartphone. One of skill in the art will further appreciate that in various embodiments the described steps may be performed in a slightly different order, or in some cases simultaneously.

The disclosed system and method has been explained above with reference to several embodiments. Other embodiments will be apparent to those skilled in the art in light of this disclosure. Certain aspects of the described method and apparatus may readily be implemented using configurations or steps other than those described in the embodiments above, or in conjunction with elements other than or in addition to those described above.

For example, the described invention may also be used with a USB-C connector. As is known in the art, the USB-C connector (not shown) uses 24 pins in a 2-row×12-pin configuration and supports connection of digital interfaces using USB 3.1 or USB 2.0 protocols, as well as including power supply connections. The connector is designed to be reversible, so that a pin in either row has a corresponding duplicate that is diagonally opposed in the other row. Four pins in the center of the USB connector are used for audio signals, with the pins designated as A6 and B6 both carrying the right audio channel and pins A7 and B7 both carrying the left audio channel. As with other prior art connectors, the return path for both channels is a common ground path.

It will be apparent to one of skill in the art in light of the teachings herein that, since there are four pins carrying audio signals, rather than having two pairs of two pins each carry duplicate signals, alternatively two pins may carry the normal left and right audio channel signals, and the other two pins may carry the left and right channel signals of opposite phase as described above. In such a case, the connector will not be completely reversible, but reversing the connector will only result in all four audio signals being reversed in phase, which few users will be able to notice.

In other embodiments, the analog output port of a smartphone may also be connected to a line input of another device, such as the amplifier of an external stereo system. In such a case, the load impedances for the left and right channel signals might typically be from about 10,000 ohms to 100,000 ohms, with 22,000 ohms being common. Similarly, a connected headphone might be a noise canceling headphone, in which case the connections will be the same as either the 3-pole or 4-pole CTIA or OMTP headphones discussed above, but the load impedance on the left and right channels is higher due to an amplifier that is integrated into the headphone, with 10,000 ohms being typical.

Where elements are shown as connected, they may in some embodiments be coupled to each other through another element or component. One of skill in the art will also appreciate how to determine parameters of the components depending on other components in the smartphone or mobile device.

These and other variations upon the embodiments are intended to be covered by the present disclosure, which is limited only by the appended claims.

1. A mobile audio device for producing a balanced stereo signal, comprising:
an analog audio output socket having 4 poles and configured to receive a 4-pole jack corresponding to either a CTIA or OMTP standard;
a first amplifier configured to provide a left channel audio signal;
a second amplifier configured to provide a right channel audio signal;
a third amplifier configured to provide an inverted left channel audio signal of opposite phase to the left channel audio signal;
a fourth amplifier configured to provide an inverted right channel audio signal of opposite phase to the right channel audio signal; and
a controller configured to:
measure the impedances between a first pole of the socket and a second pole of the socket, the first pole and a third pole of the socket, a fourth pole of the socket and the second pole, and the fourth pole and the third pole;
determine a type of sound reproduction device connected to the socket by comparing the measured impedances to expected values for devices using 3-pole jacks, devices using 4-pole jacks corresponding to the CTIA or OMTP standards, and devices using 4-pole jacks that can accept a balanced stereo signal;
if the connected sound reproduction device is determined to be one that can accept a balanced stereo signal, cause the left channel audio signal to be provided to a first pole of the output socket corresponding to a Tip of the jack, the right channel audio signal to be provided to a second pole of the output socket corresponding to a Ring1 of the jack, the inverted left channel audio signal to be provided to a third pole of the output socket, and the inverted right channel audio signal to be provided to a fourth pole of the output socket.

2. The mobile audio device of claim 1, wherein the socket is sized to receive a standard 3.5 mm jack.

3. The mobile audio device of claim 1, wherein the socket is sized to receive a standard 2.5 mm jack.

4. The mobile audio device of claim 1 wherein the analog output socket is configured to receive a 4-pole jack corresponding to the CTIA standard, and the third pole of the socket corresponds to a Ring2 of the jack and the fourth pole of the socket corresponds to a Sleeve of the jack.

5. The mobile audio device of claim 1 wherein the analog output socket is configured to receive a 4-pole jack corresponding to the OMTP standard, and the third pole of the socket corresponds to a Sleeve of the jack and the fourth pole of the socket corresponds to a Ring2 of the jack.

6. The mobile audio device of claim 4, wherein the controller is further configured to, if the connected sound reproduction device is determined to be a CTIA device, open switches to disconnect the outputs of the third and fourth amplifiers from the third and fourth poles of the socket, to close a switch to connect the pole of the socket corresponding to Ring2 of the jack to ground, and to connect the pole of the socket corresponding to the Sleeve of the jack to a microphone.

7. The mobile audio device of claim 5, wherein the controller is further configured to, if the connected sound reproduction device is determined to be an OMTP device, open switches to disconnect the outputs of the third and fourth amplifiers from the third and fourth poles of the socket, to close a switch to connect the pole of the socket corresponding to the Sleeve of the jack to ground, and to connect the pole of the socket corresponding to Ring2 of the jack to a microphone.

8. The mobile audio device of claim 4, wherein the controller is further configured to, if the connected sound reproduction device is determined to be a 3-pole device, open switches to disconnect the outputs of the third and fourth amplifiers from the third and fourth poles of the socket, and to close switches to connect the poles of the socket corresponding to Ring2 and the Sleeve of the jack to ground, such that the audio device delivers a stereo signal through a 3-pole jack.

9. The mobile audio device of claim 5, wherein the controller is further configured to, if the connected sound reproduction device is determined to be a 3-pole device, open switches to disconnect the outputs of the third and fourth amplifiers from the third and fourth poles of the socket, and to close switches to connect the poles of the socket corresponding to Ring2 and the Sleeve of the jack to ground, such that the audio device delivers a stereo signal through a 3-pole jack.

10. A method of producing a balanced stereo signal from a mobile audio device having an analog audio output socket with 4 poles and configured to receive a 3-pole jack or a 4-pole jack corresponding to either a CTIA or OMTP standard, comprising:
measuring the impedances between a first pole of the socket and a second pole of the socket, the first pole and a third pole of the socket, a fourth pole of the socket and the second pole, and the fourth pole and the third pole;
determining a type of sound reproduction device connected to the socket by comparing the measured impedances to expected values for attached sound reproduction devices using 3-pole jacks, devices using 4-pole jacks corresponding to the CTIA or OMTP standards, and devices using 4-pole jacks that can accept a balanced stereo signal;
if the attached sound reproduction device is determined to be one that can accept a balanced stereo signal:
providing a left channel audio signal to a first pole of the socket corresponding to a Tip of the jack;
providing a right channel audio signal to a second pole of the socket corresponding to a Ring1 of the jack;
providing an inverted left channel audio signal of opposite phase to the left channel audio signal to a third pole of the socket; and
providing an inverted right channel audio signal of opposite phase to the right channel audio signal to a fourth pole of the socket.

11. The method of claim 10 further comprising, if the socket is configured to receive a jack corresponding to the CTIA standard, providing an inverted left channel audio signal further comprises providing the inverted left channel audio signal to a third pole of the output socket corresponding to a Ring2 of the jack, and providing an inverted right channel audio signal further comprises providing the inverted right channel audio signal to a fourth pole of the output socket corresponding to a Sleeve of the jack.

12. The method of claim 10 further comprising, if the socket is configured to receive a jack corresponding to the OMTP standard, providing an inverted left channel audio signal further comprises providing the inverted left channel audio signal to a third pole of the output socket corresponding to a Sleeve of the jack, and providing an inverted right channel audio signal further comprises providing the inverted right channel audio signal to a fourth pole of the output socket corresponding to a Ring2 of the jack.

13. The method of claim 10, further comprising, if the attached sound reproduction device is determined to be a CTIA device, disconnecting the outputs of the third and fourth amplifiers from the third and fourth poles of the socket, connecting the pole of the socket corresponding to a Ring2 of the jack to ground, and connecting the pole of the socket corresponding to a Sleeve of the jack to a microphone.

14. The method of claim 12, further comprising, if the attached sound reproduction device is determined to be an OMTP device, disconnecting the outputs of the third and fourth amplifiers from the third and fourth poles of the socket, connecting the pole of the socket corresponding to a Sleeve of the jack to ground, and connecting the pole of the socket corresponding to a Ring2 of the jack to a microphone.

15. The method of claim 10 further comprising, if the attached sound reproduction device is determined to be a 3-pole device, disconnecting the outputs of the third and fourth amplifiers from the third and fourth poles of the socket, and connecting the poles of the socket corresponding to a Ring2 and a Sleeve of a 4-pole jack to ground, such that the audio device delivers a stereo signal through a 3-pole jack.
